(19) United States
(12) Patent Application Publication
(10) Pub. No.: US 2007/0213171 A1
(43) Pub. Date: Sep. 13, 2007

(54) Gear assembly

(76) Inventors: William P. Pizzichil, Easley, SC (US); L. Keith Taliaferro JR., Greenville, NC (US); Yogendra K. Sharma, Greenville, SC (US); Chuong Huy Nguyen, Simpsonville, SC (US)

Correspondence Address: THOMPSON COBURN, LLP, ONE US BANK PLAZA, SUITE 3500, ST LOUIS, MO, 63101, US

(21) Appl. No.: 11/374,442

(22) Filed: Mar. 13, 2006

(51) Int. Cl. F16H 57/08

(52) U.S. Cl. 475/331

(57) ABSTRACT

The present technique, in accordance with certain embodiments, provides a novel gearing assembly. The exemplary assembly includes a planetary or epicyclic gear set that provides the final gear reductions from the output shaft. Specifically, the use of a planetary gear set for final reduction transfers rotation and torque to four planet gears, for instance, which drive a carrier assemblies that, in turn, causes rotation of the output shaft. Advantageously, such an assembly can provide high torque-levels (e.g., 300,000 inch-pounds) via a relatively small-sized device.

### BACKGROUND

The present technique relates generally to a gearing assembly and, in one exemplary embodiment, to a gearing assembly for high power-density applications.

In various industrial applications, such as mining applications, high power and torque levels are desirable. For instance, a conveyor system at a mining location may employ torque levels ranging from 100,000 inch-pounds of torque to 6,300,000 inch-pounds of torque, and beyond. To effectuate the production of such torque levels, gearing assemblies or gearboxes are often employed. Such gearboxes traditionally receive rotational input from a motor and, in turn, produce a torque output at a rate of rotation better suited for the output (i.e., driven) mechanism.

Unfortunately, traditional gearboxes, to realize such torque levels, are relatively large in size, consuming valuable real estate in confined locations, often found in mine shafts and at other mining operations. In fact, the maintenance of traditional gearboxes is often difficult when in situ, due to the limited space at the operation site. Moreover, traditional gearboxes are relatively heavy, making the transportation and installation of such gearboxes relatively burdensome tasks. Further still, the large size of traditional gearboxes requires additional materials for fabrication, increasing the associated costs of manufacture.

The power density of a gearing system may be defined as the ratio between the power that can be transmitted (generally a product of the speed and torque) and the size or volume of the gearing system. Power density is a particular problem in traditional gearbox designs, particularly problematical in mining applications. The very limited spaces within mines, and the very demanding power requirements make power density. Conventional gearboxes, often designed for other applications and combined in various ways to increase the gear reduction, are simply incapable of providing the increased power densities now needed in mining and similar applications.

Therefore, there exists a need for improved gearing assemblies, particularly for high power-density and high torque applications.

### BRIEF DESCRIPTION

The present technique provides a novel gearing assembly designed to respond to such needs. The invention may be used in a number of environments, but is particularly well suited to mining applications. A qualitative difference in power density as compared to heretofore available gearing systems is provided by the integration of a planetary gear reduction stage to a parallel helical bevel gearbox. These components are, then, not just assembled from separately available products, but fully integrated to reduce the volume of the resulting unit and thereby to increase its power density.

An exemplary assembly includes a planetary or epicyclic gear set that provides the final gear reductions for the output shaft. Specifically, the use of a planetary gear set for final reduction transfers rotation and torque to four planet gears, for instance, which drive a carrier assembly that, in turn, causes rotation of the output shaft.

By way of example, the gearing assembly can include a bevel gear that is driven by the input shaft of the assembly, which is coupled to the drive motor. The bevel gear facilitates a ninety-degree translation in the output torque and rotation from the motor. The bevel gear set then drives a further gear assembly that, in turn, drives the sun gear of a planetary gear set. By preventing rotation of a ring gear, the planet gears revolve about the sun gear's axis, resultantly driving the carrier in which the planetary gears reside. The gearing assembly's output shaft is driven by rotation of the carrier, thus producing the appropriate output torque and rate of rotation for the driven device (e.g., a conveyor belt). Indeed, the exemplary gearing assembly is operable to provide 300,000 inch-pounds of torque, and beyond, to the output shaft.

In accordance with another exemplary embodiment, the input shaft may be geared in a parallel manner with the output shaft, with the final gear reduction being provided by a similar planetary gear set. This gearing assembly, too, is operable to provide 300,000 inch-pounds of torque, and beyond. Of course, the foregoing are merely but exemplary embodiments of the present technique, certain embodiments of which are described in detail below.

### DRAWINGS

These and other features, aspects, and advantages of the present technique will become better understood when the following detailed description is read with reference to the accompanying drawings in which like characters represent like parts throughout the drawings, wherein:

FIG. 1 is a diagrammatic representation of a conveyor system having a gearing assembly, in accordance with an exemplary embodiment of the present technique;

FIG. 2 is a side view of the gearing assembly introduced in FIG. 1;

FIG. 3 is a cross-sectional view of the gearing assembly of FIG. 1 taken along line 3-3 of FIG. 1; and

FIG. 4 is a diagrammatic illustration of a planetary gear set of an exemplary gearing assembly in motion, in accordance with an exemplary embodiment of the present technique.

### DETAILED DESCRIPTION

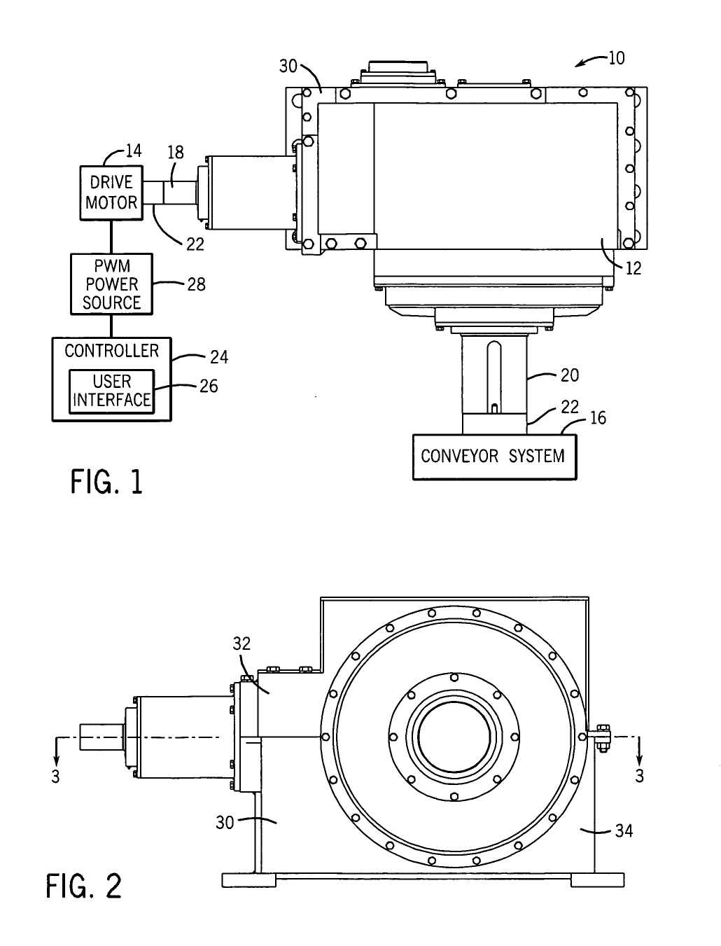

Turning to the drawings, FIG. 1 illustrates an exemplary conveyor system 10 having a gearing assembly 12 operable to translate the direction and magnitude of torque provided by a torque-producing device, such as a drive motor 14, to a driven device, such as a conveyor system 16, in accordance with an exemplary embodiment of the present technique. Prior to continuing, however, it is again worth noting that the following discussion merely relates to exemplary embodiments of the present technique. Indeed, the present technique provides benefits to any number of gearing assemblies, and is applicable to parallel input/output shaft gearing assemblies as well, for instance. As such, the appended claims should not be viewed as limited to those embodiments discussed herein.

Returning to FIG. 1, the gearing assembly 12 is illustrated from the top, providing a view of the input shaft 18 and the output shaft 20 concurrently. As the torque-receiving end of the gearing assembly 12, the input shaft 18 is coupled to the drive motor 14 via coupling mechanism 22, the details of which would be appreciated by those of ordinary skill in the art. During operation, the drive motor 14 converts electrical energy into rotational motion, thus providing torque to the input shaft 18 that, ultimately and as explained in detail below, is routed to the output shaft 20 to drive the conveyor system 16. Like the input shaft 18, the output shaft 20 includes a coupling mechanism 22 that mechanically links the shaft 20 to the conveyor system 16.

As illustrated, the drive motor 14 is a variable speed drive, which allows for operation various rates of rotation. The drive motor 14 operates under the direction of a controller 24, which includes a user interface 26 for bi-directional communication with an operator, or a higher-level controller. Specifically, the controller 24 commands a pulse-width-modulator (PWM) power source 28, the output frequency from which determines the rotational speed at which the drive motor 14 operates. Of course, the drive motor 14 may be one of any number of kinds of motors (e.g., totally enclosed, fan cooled, explosion proof, or even a direct current motor, or, a permanent magnet motor, etc.), and the power source 28 may too be one of any number of kinds compatible with the drive motor employed, as would be appreciated by those of ordinary skill in,the art.

Although the input shaft 18 and the output shaft 20 extend into the surrounding environment, the vast majority of the components of the gearing assembly 12 are disposed internally with respect to a housing 30. Advantageously, the housing 30 provides protection to these internal components by retarding the ingress of containments from the environment, for instance. This housing 30 presents a split assembly, as best illustrated in FIG. 2, comprising an upper housing 32 and a lower housing 34. Because of this bifurcated construction, the upper housing 32 can be separated from the lower housing 34, affording access to the internal components of the gearing assembly 12 and, thus, facilitating maintenance or repair operators, as well as assembly.

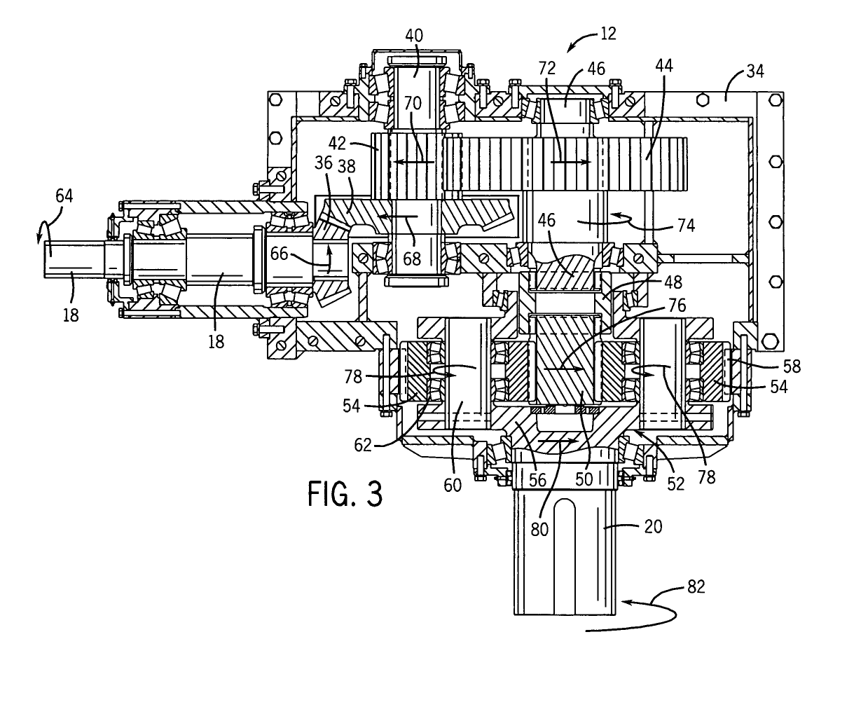

FIG. 3, which is a cross-sectional view of the gearing assembly 12 along line 3-3 of FIG. 1, well illustrates the internal components of the exemplary gearing assembly 12. As discussed above, the torque and rotation generated by the drive motor is transferred to the input shaft 18. Disposed on the inboard end of the input shaft 18 is a first bevel gear 36. The rotation of the first bevel gear 36 is fixed with respect to the input shaft 18, i.e., the input shaft 18 and the first bevel gear 36 have the same rate of rotation.

In the exemplary gearing assembly 12, the first bevel gear 36 engages with a second bevel gear 38 mounted on an internal shaft 40 disposed transverse with respect to the input shaft 18. During operation, this engagement transfers the rotation and torque of the input shaft 18 to the second bevel gear 38. As illustrated, the second bevel gear 38 has a greater number of teeth and a greater diameter than the first bevel gear 36. Thus, the internal shaft 40 has a lesser rate of rotation than the input shaft 18, with the second bevel gear 38 acting as a speed reducer. However, the torque transferred is increased by the relationship. The first and second bevel gears have a gear ratio greater than one, and, as such, the engagement acts to reduce the transferred rate of rotation but to increase the transferred torque. Advantageously, the teeth of the first and second bevel gears may have corresponding helical geometries, to improve the engagement and transfer of torque therebetween. Of course, as would be appreciated by those of ordinary skill in the art, a variety of gearing geometries may be employed. In the present embodiment, the bevel gear set provides a reduction ratio of X to Y or from X:Y to X:Z. (Bill, can you let me know this gear ratio.)

The internal shaft 40 carries a first gear 42 that rotates in conjunction with the internal shaft 40. That is, the internal shaft 40 and the first gear 42, during operation, have the same rate of rotation. The first gear 42 engages with a second gear 44 that is mounted on a second internal shaft 46. Similar to the internal shaft 40 and the first gear, the rate of rotation of the second gear 44 and the second internal shaft 46 are the same during operation. However, because the second gear 44 has a greater number of teeth and greater diameter than the first gear 42, the rate of rotation of the second internal shaft 46 is less than the rate of rotation of the internal shaft 40. In other words, the established gear ratio between these two round gears effectuates a reduction in the rate of rotation transferred from the internal shaft 40 to the second internal shaft 46 but effectuates an increase in the torque transferred from the internal shaft 40 to the second internal shaft 46. Advantageously, the gearing geometries between the first and second round gears may be helical, with involute engagement, to improve the transfer of torque and rotation therebetween. In the present embodiment, the set of gears 42, 44, provides a reduction ratio of X:Y. (Bill, please again provide me with a gear ratio.)

The more inboard end of the second internal shaft 46 carries a shaft coupling assembly 48. This shaft coupling assembly 48 facilitates a mechanical linking of the second internal shaft 46 with a sun gear 50 or central gear of a planetary gear set 52, details of which are discussed below. Advantageously, the exemplary shaft coupling assembly 48 facilitates mechanical engagement of the second internal shaft 46 with a wide variety of planetary gear systems having sun gears of various sizes and geometries.

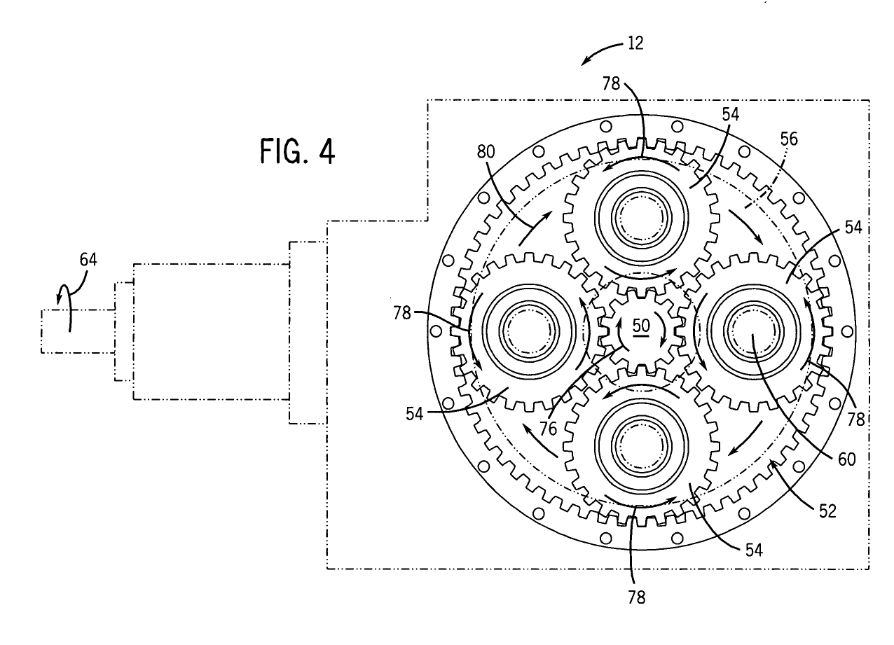

Focusing on the planetary gear set 52, and referencing FIG. 4 as well, the exemplary planetary gear set 52 includes a sun gear 50 surrounded by a plurality of planetary gears 54 mounted in a carrier assembly 56, and includes a stationary ring gear 58 that surrounds both the planetary gears 54 and the sun gear 50. As illustrated, the sun gear 50 is surrounded by and in mechanical engagement with four planetary gears 54. The exemplary planetary gears 54, as best illustrated in FIG. 4, present a greater number of teeth and greater diameter than the sun gear 50. Thus the planetary gears 54 act as reducers to lessen the rate of rotation from the sun gear 50, and effectuate an increase in the torque transferred to the planetary gears 54 from the sun 50. These planetary gears 54 are housed in and supported by the carrier assembly 56. By way of example, each planetary gear 54 is mounted on a planet shaft 60 that extends through and is supported by the carrier 56. Each planet shaft 60 is maintained in a fixed relationship with respect to the carrier assembly 56 by a cotter pin or other retaining devices, while roller bearings 62 interposed between the outer surface of each planet shaft 60 and the inner surface of each re spective planetary gear 54 facilitate rotation of the given planetary gear 54.

Additionally, as is discussed further below, the rotation of the planetary gears 54 also causes the carrier assembly 56 to rotate about the axis of the sun gear 50 as well. Thus, each planetary gear 54 not only rotates about its own axis but also revolves about the axis of the sun gear 50 and in conjunction with the carrier assembly 56. As illustrated, the carrier assembly 56 includes the output shaft 20, which is integrated into the structure of the output shaft 20. Accordingly, the rate of rotation of the carrier assembly 56 defines the rate of the rotation of the output shaft 20. Thus, as is explained in detail below, the mechanism above facilitates the transfer of rotation and torque from a torque-producing device to the output shaft, to drive a machine element, for instance. In a present embodiment, planetary gear shaft provides a revolution ratio of X:Y. (Bill, again please provide the gear ratios.)

Specifically, as best illustrated in FIGS. 3 and 4, the input shaft 18 of the exemplary system 10 receives a leftward or counterclockwise torque, as represented by directional arrow 64. Because the rotation of the first bevel gear 36 is fixed with respect to the rotation of the input shaft 18, the first bevel gear 36 also rotates in a counterclockwise direction, as represented by directional arrow 66. The first bevel gear 36 transfers torque to the second bevel gear 38, causing the second bevel gear 38 to rotate in the direction represented by arrow 68. Again, the greater number of teeth and greater diameter of the second bevel gear 38 in comparison to the bevel gear 36 produce a speed reducing but torque increasing relationship with respect to transferred rotation from the first bevel gear 36.

The first gear 42, because its rotation is fixed with respect to the first internal shaft 40, rotates at the same rate of rotation as the second bevel gear 38, as represented by directional arrow 70. However, the second gear 44 rotates in a direction opposite to the first gear 42, as represented by directional arrow 72. Again, the greater number of teeth and diameter of the second gear 44 in comparison to the first gear 42 effectuates a reduction in the transferred rate of rotation and an increase in the transferred torque from the first gear 42.

The second internal shaft 46 on which the second gear 44 is mounted then rotates in the same direction, as represented by directional arrow 74, and at the same rate of rotation. Via the coupling mechanism 48, the sun gear 50 of the planetary gear set 52 rotates in the same direction as the second internal shaft 46, as represented by directional arrow 76, and at the same rate of rotation.

This rotation of the sun gear 50 then drives rotation of the planetary gears 54. As best illustrated in FIG. 4, rotation of the sun gear 50 in a clockwise direction (set arrows 76) causes each of the planetary gears 54 to rotate in a counterclockwise direction, as represented by directional arrows 78. Again, because of the relationship between the number of gear teeth and the comparative diameters, the rate of rotation of the planetary gears 54 is less than that of the sun gear 50, however, the transferred torque is increased.

The planetary gears 54 not only rotate about their own individual axes but also revolve about the axis of the sun gear, causing the carrier assembly 56 to rotate as well, as represented by directional arrows 80. Specifically, the illustrated carrier assembly 56 of FIG. 4 rotates in a clockwise direction, which is the same direction as the sun gear 50. This rotation, because the output shaft 20 is integrated or otherwise mechanically linked to the carrier assembly 56, causes the output shaft 20 to rotate at the same rate of rotation and in the same direction, as represented by directional arrow 82 of FIG. 3.

Advantageously, through the use of a planetary gear set 52 at the final stage, an increase in torque and a reduction in speed can be effectuated through the four gears, which facilitate a split of power torque paths. In fact, the use of the planetary gear set 52 enables the transmission of high-levels of torque (e.g., 300,000 inch-pounds, 1,000,000 inch-pounds, 3,000,000 inch-pounds, and beyond) to provide high-power transfer. Moreover, such levels of torque can be achieved with smaller devices, in both volume and weight as compared to existing systems, that rely on wholly parallel shaft techniques. For instance, such high-torque levels can be obtained through a gearing assembly having a weight of 20,000 pounds or less, in turn providing cost advantages during both manufacture and use.

As discussed above, the foregoing structure provides a fully integrated reduction system in which the bevel gearing stage and the planetary gearing stage, with the spur gearing therebetween, are disposed in a very compact package, particularly considering the power transmission rating. This is due, in part to the arrangement of shaft 46, sun gear 50, and coupling 48, along with the fully integrated housing in which the various gear stages are arranged. The power density of the resulting product is then significantly increased as compared to heretofore known arrangements. The higher power density makes the system particularly suitable for mining and similarly space-constrained applications where high powers are required.

While only certain features of the invention have been illustrated and described herein, many modifications and changes will occur to those skilled in the art. It is, therefore, to be understood that the appended claims are intended to cover all such modifications and changes as fall within the true spirit of the invention. In fact, the above-described technique is applicable to host of design variation, including both 90 degree and parallel input-output shafts, for instance. Moreover, the present technique, inclusive of the exemplary embodiments herein, is applicable to situations in which the above-described output shaft is coupled to the torque-producing device and the input shaft is coupled to the driven machine, the gearing assembly then acting as a torque reducer/speed multiplier system. Similarly, either the input shaft or output shaft, or both, may be configured as a hollow member or hub for receiving a machine shaft. In such cases, the “hub” on either the input or output side of the system should be considered to correspond to the respecting “shaft” of the amended claims.

1. An integrated gearing assembly, comprising:
a housing;
an input shaft at least partially disposed in the housing, the input shaft having a first bevel gear disposed thereof;
a first gear set disposed in the housing and having a second bevel gear configured to receive torque from the first bevel gear; and
a planetary gear set disposed in the housing, wherein a sun gear of the planetary gear set is configured to receive torque from the first gear set, the planetary gear set comprising:
a plurality of planet gears disposed about the sun gear;
a carrier assembly configured to support the plurality of planetary gears and including an output shaft; and
a fixed ring gear disposed about the plurality of planetary gears;
wherein the planetary gear set is operable to provide at least 300,000 inch-pounds of torque to the output shaft.

2. The gearing assembly of claim 1, wherein the output shaft is integral with respect to the carrier assembly.

3. The gearing assembly of claim 1, wherein the planetary gear set is operable to provide at least 1,000,000 inch-pounds of torque to the output shaft.

4. The gearing assembly of claim 1, wherein the planetary gear set is operable to provide at least 3,000,000 inch-pounds of torque to the output shaft.

5. The gearing assembly of claim 1, wherein the gearing assembly weighs less than 20,000 pounds.

6. An integrated gearing assembly, comprising:
a housing;
an input shaft extending from the housing;
a first gearing set configured to receive torque from the input shaft; and
a planetary gear set disposed in the housing and mechanically coupled to the first gearing set, the planetary gear set comprising:
a sun gear operable to receive torque from the first gearing set;
a plurality of planetary gears disposed in a carrier assembly and about the sun gear; and
a stationary ring gear disposed about the sun gear and the plurality of planetary gears;
wherein the carrier assembly commands rotation of an output shaft; and
wherein the planetary gear set is operable to provide at least 300,000 inch-pounds of torque to the output shaft.

7. The gearing assembly of claim 6, wherein the planetary gear set is operable to provide at least 3,000,000 inch-pounds of torque to the output shaft.

8. The gearing assembly of claim 6, wherein the input shaft is disposed at 90 degrees with respect to the output shaft.

9. The gearing assembly of claim 6, wherein the input shaft is generally parallel to the output shaft.

10. An integrated gearing assembly, comprising:
a housing;
an input shaft and coupleable to a torque-providing device, the input shaft having a first bevel gear disposed on of the shaft and inside the housing;
a first internal shaft having a second bevel gear in engagement with the first bevel gear, and having a first round gear disposed thereon;
a second internal shaft having a second intermediate gear disposed thereon, the second intermediate gear being in engage with the first intermediate gear;
a planetary gear set disposed in the housing and comprising a sun gear configured to receive torque from the second internal shaft, a plurality of planet gears disposed about the sun gear and housed in a carrier assembly, and a stationary ring gear disposed about the plurality of planetary gears and the sun gear; and
an output shaft, wherein the rotation of the carrier assembly defines the rotation of the output shaft.

11. The gearing assembly of claim 10, wherein the second bevel gear includes a greater number of teeth than the first bevel gear.

12. The gearing assembly of claim 11, wherein the second intermediate gear includes a greater number of teeth than the first intermediate gear.

13. The gearing assembly of claim 12, wherein each planetary gear includes a greater number of teeth than the sun gear.

14. The gearing assembly of claim 10, wherein the planetary gear set is operable to provide at least 300,000 inch-pounds of torque to the output shaft.

15. The gearing assembly of claim 14, wherein the planetary gear set is operable to provide at least 3,000,000 inch-pounds of torque to the output shaft.

16. The gearing assembly of claim 10, wherein the output shaft integrated with respect to the carrier assembly.

17. The gearing assembly of claim 10, wherein the planetary gear set includes four planetary gears.

18. A method of operating a gearing assembly, comprising:
providing an input shaft operable to receive an input torque from a torque-producing device; and
routing torque from the input shaft to a planetary gear set, the planetary gear set being operable to rotate an output shaft that is askew with respect to the input shaft, such that the planetary gear set provides at least 300,000 inch-pounds of torque to the output shaft.

19. The method of claim 18, comprising providing at least 1,000,000 inch-pounds of torque to the output shaft.

20. A method of manufacturing an integrated gearing assembly, comprising:
disposing a first shaft extending from a housing;
disposing a first gearing set in the housing, the first gearing set being configured to receive torque from the first shaft;
disposing a planetary gear set in the housing, the planetary gear set being mechanically coupled to the first gearing set, the planetary gear set comprising:
a sun gear operable to receive torque from the first gearing set; and
a plurality of planet gears disposed in a carrier assembly and about the sun gear; and
a stationary ring gear disposed about the sun gear and the plurality of planetary gears;
wherein the carrier assembly commands rotation of a second shaft extending from the housing, and wherein the planetary gear set is operable to provide at least 300,000 inch-pounds of torque to the second shaft.
